(19) United States
(12) Patent Application Publication
(10) Pub. No.: US 2023/0336492 A1
(43) Pub. Date: Oct. 19, 2023

(54) TRANSPORT NETWORK SLICE CONTROL DEVICE AND CONTROL PLANE ENTITY FOR A TIME SENSITIVE NETWORK-BASED TRANSPORT NETWORK

(71) Applicant: HUAWEI TECHNOLOGIES CO., LTD., Shenzhen (CN)

(72) Inventors: Kostas KATSALIS, Munich (DE); Xueli An, Munich (DE); Tongtong Wang, Beijing (CN); Charles Sheridan, Munich (DE)

(73) Assignee: HUAWEI TECHNOLOGIES CO., LTD., Shenzhen (CN)

(21) Appl. No.: 18/314,680

(22) Filed: May 9, 2023

Related U.S. Application Data
(63) Continuation of application No. PCT/CN2020/127571, filed on Nov. 9, 2020.

(51) Int. Cl. H04L 47/28; H04L 47/24

(52) U.S. Cl. CPC H04L 47/28; H04L 47/24

(57) ABSTRACT

The present disclosure relates to a transport network slice control device and a Time Sensitive Network (TSN) control plane entity for a TSN-based Transport Network (TN). The transport network slice control device comprises a first interface configured to communicate with a transport network slice management entity of a mobile network, and a second interface configured to communicate with the TSN control plane entity.

### CROSS-REFERENCE TO RELATED APPLICATIONS

This application is a continuation of International Application No. PCT/CN2020/127571, filed on Nov. 09, 2020, the disclosure of which is hereby incorporated by reference in its entirety.

### TECHNICAL FIELD

The present disclosure relates generally to the field of communication networks, and particularly, to devices and methods for interconnecting a network slice control management system of a mobile network with a Time-Sensitive Network (TSN) control plane.

To this end, the disclosure presents a transport network slice control device, a TSN control plane entity for a TSN-based Transport Network (TN), and corresponding methods. The transport network slice control device is configured to communicate with a transport network slice management entity of a mobile network, and is configured to communicate with a TSN control plane entity of a TSN-based TN. Moreover, the TSN control plane entity is configured to communicate with the transport network slice control device of the mobile network.

### BACKGROUND

Generally, network slicing is a design paradigm that enables sharing of resources and functions on a per slice basis. Further, the Services and Systems Aspects (SA) of the 3rd Generation Partnership Project (3GPP), including SA1, SA2, and SA5 groups, investigate architecture and process issues related to network slicing. Moreover, using network slicing over the same Fifth Generation (5G) system, multiple network slice instances may operate in order to support Ultra-Reliable (UR) Low Latency Communications (URLLC) and enhanced Mobile Broadband (eMBB) at the same time, where a specific user flow may be associated with a specific network slice.

Furthermore, the 3GPP SA and Radio Access Network (RAN) groups are creating technical specifications to combine the concept of slicing for the RAN and the Core to create an end-to-end network slice.

For example, the 3GPP SA1 provides use cases that may be enabled via network slicing. Moreover, the 3GPP SA2 provides a discussion for an architecture for realizing the network slicing in 3GPP networks. Furthermore, the architecture is described in TS23.501 where the signaling parts are described in, for example, TR.23.799 and TS23.502, and the network management and orchestration aspects are described in 3GPP SA5.

Regarding the transport network (TN), the 3GPP provides a relevant network slice management TN-Network Slice Subnet Management Function (NSSMF) entity. This entity is responsible for the lifecycle management of the Transport Network Slice Instances. However, 3GPP is not responsible for the actual operation and control of the TN. As the requirements are driving the Transport Network technology deployment and configuration, different technologies have been proposed and are currently operating to satisfy Network Slice requirements.

Internet Engineering Task Force (IETF) specifies a “Transport Slice Multilayer Controller” to parse, for example, TN requirements on per slice basis. However, the actual operation of the Transport network relies on technology specific configuration and optimizations.

A technology that is able to enable deterministic performance guarantees in Transport Networks is IEEE Time Sensitive Networking (TSN). The way to incorporate the 5G system as a TSN bridge is described in, for example, TS 23.501, TS 23.502, and TS 23.503. Moreover, from the IEEE perspective, 802.1CM resulted from a collaborative effort of CPRI and IEEE 802.1 to exploit TSN as a solution for the fronthaul link. 802.1CM describes how to meet the stringent fronthaul requirements in an Ethernet-based bridged network. TSN networks can support not only fronthaul traffic but also other traffic types traversing concurrently the network and are able to provide deterministic communications, not only by means of throughput but also by means of delay and jitter.

It is generally desirable to improve devices and methods for supporting the TSN in mobile networks.

### SUMMARY

In view of the above-mentioned problems and disadvantages, embodiments of the present disclosure aim to improve conventional transport network slice control devices and Time Sensitive Network (TSN) control plane entities and methods for communication networks.

An objective is to connect a network slice control management system (e.g., transport network slice control devices) with a TSN control plane (e.g., with a TSN control plane entity). For example, one or more interfaces should be able to manage network slicing for an IEEE TSN-based network. Moreover, a TSN control plane entity is provided that should be able to support network slicing features.

Another objective is to enable network slicing over an IEEE TSN-based unified transport network. For example, it should be possible that, besides the fronthaul link, the TSN technology can be also used to support also backhaul and midhaul connectivity, in the case of, for example, disaggregated RAN.

Yet another objective is to communicate dynamically network slice requirements from the 3GPP Mobile Network to the TSN CUC/CNC control plane. For example, it should be possible that the 3GPP mobile network may dynamically map a slice request to the underlying TSN network, while TSN network also reports traffic flow requirements to the 3GPP mobile network in order to perform the relevant resource allocation on a per network slice basis.

One or more objectives are achieved by the embodiments of the disclosure as described in the enclosed independent claims. Advantageous implementations of the embodiments of the disclosure are further defined in the dependent claims.

A first aspect of the present disclosure provides a transport network slice control device, the transport network slice control device comprising a first interface configured to communicate with a transport network slice management entity of a mobile network, and a second interface configured to interface with a Time Sensitive Network (TSN) control plane entity of a TSN-based Transport Network (TN).

The transport network slice control device may be, or may be incorporated in, a physical entity such as an electronic device, e.g., a computer, a server computer, etc., or a logical entity. For example, the transport network slice control device may be a transport slice multilayer controller. This multilayer controller considers not only TSN related information but also other layer 2 layers, such as a VLAN, layer 3 and layer 4 network operations.

The transport network slice control device comprises the first interface that may communicate with the transport slice management entity. The transport slice management entity may be, for example, a TN-Network Slice Subnet Management Function (TN-NSSMF) entity of a mobile network.

The transport network slice control device further comprises the second interface that may interface the TSN control plane entity. The TSN control plane entity may be, for example, a control plane of IEEE TSN-based transport network.

For example, the transport network slice control device of the first aspect (e.g., a transport slice multilayer controller) may comprise the first interface to enable communication with the transport slice management entity of the mobile network (e.g., the NSSMF entity of the mobile network) and the second interface to enable communication with the control plane entity of the TSN-based TN (e.g., a control plane of IEEE TSN-based transport network).

In an implementation form of the first aspect, the transport network slice control device is further configured to send or receive, via the first interface, network slice control and management information to or from the transport network slice management entity of the mobile network, and/or send or receive, via the second interface, network slice control and management information required by the TSN network, to or from the TSN control plane entity.

In particular, the transport network slice control device may enable capability exposure of the TSN-based transport network performance attributes and requirements to the 3GPP mobile network.

In a further implementation form of the first aspect, the network slice management information comprises one or more of:
a TSN-TN network slice requirement information,
a TSN-TN slice instance creation request,
a TSN-TN slice instance creation response,
a TSN-TN slice instance state information,
a TSN-TN slice instance policy information,
a TSN-TN slice instance configuration information,
a TSN-TN slice instance run action,
a TSN-TN slice instance decommissioning action,
a soft TSN slice instance capability, or
a hard TSN slice instance capability.

In a further implementation form of the first aspect, the transport network slice control device is further configured to receive, via the first interface, updated TN slice information or updated TN slice resource provision from the transport slice management entity of the mobile network, and/or send, via the second interface to the TSN control plane entity, the updated TN slice information or the updated TN slice resource provision.

For example, the transport network slice control device may receive TSN updates on per TSN slice basis, TSN updates for stream performance, user slice participation update, etc.

In a further implementation form of the first aspect, the transport network slice control device is further configured to receive a TN slice isolation requirement from the transport slice management entity of the mobile network and maintain a TN slice isolation over a TSN-based data plane, based on the received TN slice isolation requirement.

A second aspect of the disclosure provides a Time Sensitive Network (TSN) control plane entity for a TSN-based Transport Network (TN), the TSN control plane entity being configured to receive, through a transport network slice control device, network slice management information passed from a transport slice management entity of the mobile network, expose capability information of the TSN-based TN to the network slice transport network control device, and provide the capability information of the TSN-based TN to the network slice transport network control device.

The TSN control plane entity may be, or may be incorporated in, a physical entity such as an electronic device, e.g., a computer, a server computer, etc., or a logical entity. For example, the TSN control plane entity may be a Centralized User Configuration (CUC) or Centralized Network Configuration (CNC) of an IEEE TSN-based transport network.

In an implementation form of the second aspect, the TSN control plane entity is further configured to store information in a network slice database and provide information related to a lifecycle of one or more transport network slice instances to a control plane entity of the TSN-based TN.

In a further implementation form of the second aspect, the network slice management information comprises one or more of:
a TSN-TN network slice requirement information,
a TSN-TN slice instance creation request,
a TSN-TN slice instance creation response,
a TSN-TN slice instance state information,
a TSN-TN slice instance policy information,
a TSN-TN slice instance configuration information,
a TSN-TN slice instance run action,
a TSN-TN slice instance decommissioning action,
a soft TSN slice instance capability, or
a hard TSN slice instance capability.

In a further implementation form of the second aspect, the TSN control plane entity is further configured to obtain, from the transport network slice control device, a determined TN performance attribute and map, based on the determined TN performance attribute, the received network slice management information from the transport slice management entity of the mobile network to TSN specific performance attributes of the TSN-based TN on a per slice basis.

For example, the TSN control plane entity may perform specific optimizations based on the the network slice instance description defined by 3GPP and perform the necessary resource allocation over the underlying transport topology and the link interconnections, taking into account the desired transport network performance attributes.

In a further implementation form of the second aspect, the TSN control plane entity is further configured to receive, from the transport network slice control device, a TN slice isolation requirement received from the network slice transport network management entity of the mobile network and maintain a TN slice isolation over a TSN-based data plane, based on the received TN slice isolation requirement.

For example, the TSN control plane entity may support preserving slice isolation over a converged TSN-based dataplane using specific schedulers and Gate Control Lists (GCLs) when 802.1Qbv is used.

In a further implementation form of the second aspect, the TSN control plane entity is based on a network slice aware TSN control plane entity comprising a Centralized Network Configuration (CNC) TSN control entity configured to control a TSN TN-Network Slice Sub network Instance (NSSI), or a Centralized User Configuration (CUC) TSN control entity configured to pass requirements like a TSN TN-NSSI stream specification to CNC.

In particular, the interface between CUC/CNC and Transport Network Slice Controller, called a “TSN Slice Aware Interface”, may be an interface for interconnecting network slice control management systems with a TSN centralized control plane.

In a further implementation form of the second aspect, the CNC is further configured for controlling a TSN slice aware operation and/or a TSN non-slice aware operation.

In a further implementation form of the second aspect, the TSN control plane entity comprising a database configured to store, for each TN NSSI resource, one or more of an allocation information, a resource identification, or mapping information regarding stream performance attributes.

A third aspect of the disclosure provides a system comprising at least one transport network slice control device for a mobile network, according to the first aspect or any of its implementation forms, and at least one Time Sensitive Network (TSN) control plane entity for a TSN-based Transport Network (TN), according to the second aspect or any of its implementation forms.

A fourth aspect of the disclosure provides a method for a transport network slice control device for a mobile network, the method comprising communicating, via a first interface, with a transport network slice management entity of a mobile network, and communicating, via a second interface, with a Time Sensitive Network (TSN) control plane entity of a TSN-based Transport Network (TN).

In an implementation form of the fourth aspect, the method further comprises sending or receiving, via the first interface, network slice control and management information to or from the transport network slice management entity of the mobile network, and/or sending or receiving, via the second interface, network slice control and management information required by the TSN network, to or from the TSN control plane entity.

In a further implementation form of the fourth aspect, the network slice management information comprises one or more of:
a TSN-TN network slice instance requirement information,
a TSN-TN slice instance creation request,
a TSN-TN slice instance creation response,
a TSN-TN slice instance state information,
a TSN-TN slice instance policy information,
a TSN-TN slice instance configuration information,
a TSN-TN slice instance run action,
a TSN-TN slice instance decommissioning action,
a soft TSN slice instance capability, or
a hard TSN slice instance capability.

In a further implementation form of the fourth aspect, the method further comprises receiving, via the first interface, updated TN slice information or updated TN slice resource provision from the transport slice management entity of the mobile network, and/or sending, via the second interface to the TSN control plane entity, the updated TN slice information or the updated TN slice resource provision.

In a further implementation form of the fourth aspect, the method further comprises receiving a TN slice isolation requirement from the transport slice management entity of the mobile network, and maintaining a TN slice isolation over a TSN-based data plane, based on the received TN slice isolation requirement.

The method of the fourth aspect achieves the advantages and effects described for the transport network slice control device of the first aspect.

A fifth aspect of the disclosure provides a method for a Time Sensitive Network (TSN) control plane entity for a TSN-based Transport Network (TN), the method comprising receiving, through a transport network slice control device, network slice management information passed from a transport slice management entity of the mobile network, exposing capability information of the TSN-based TN to the network slice transport network control device, and providing the capability information of the TSN-based TN to the network slice transport network control device.

In an implementation form of the fifth aspect, the method further comprises storing information in a network slice database, and providing information related to a lifecycle of one or more transport network slice instances to a control plane entity of the TSN-based TN.

In a further implementation form of the fifth aspect, the network slice management information comprises one or more of:
a TSN-TN network slice requirement information,
a TSN-TN slice instance creation request,
a TSN-TN slice instance creation response,
a TSN-TN slice instance state information,
a TSN-TN slice instance policy information,
a TSN-TN slice instance configuration information,
a TSN-TN slice instance run action,
a TSN-TN slice instance decommissioning action,
a soft TSN slice instance capability, or
a hard TSN slice instance capability.

In a further implementation form of the fifth aspect, the method further comprises obtaining, from the transport network slice control device, a determined TN performance attribute, and mapping, based on the determined TN performance attribute, the received network slice management information from the transport slice management entity of the mobile network to TSN specific performance attributes of the TSN-based TN on a per slice basis.

In a further implementation form of the fifth aspect, the method further comprises receiving, from the transport network slice control device, a TN slice isolation requirement received from the network slice transport network management entity of the mobile network, and maintaining a TN slice isolation over a TSN-based data plane, based on the received TN slice isolation requirement.

In a further implementation form of the fifth aspect, the TSN control plane entity is based on a network slice aware TSN control plane entity, the method further comprises controlling, by a TSN CNC control entity of the network slice aware TSN control plane, a TSN TN-NSSI, or passing, by a TSN CUC, a TSN TN-NSSI stream specification to the CNC.

In a further implementation form of the fifth aspect, the method further comprises controlling, by the CNC, a TSN slice aware operation and/or a non-TSN slice aware operation.

In a further implementation form of the fifth aspect, the method further comprises storing, by the TSN control plane entity comprising a database, for each TN NSSI resource, an allocation information, a resource identification, or mapping information regarding stream performance attributes.

The method of the fifth aspect achieves the advantages and effects described for the TSN control plane entity of the second aspect.

A sixth aspect of the present disclosure provides a computer program comprising a program code for performing the method according to the fourth aspect or the fifth aspect or any of their implementation forms.

A seventh aspect of the present disclosure provides a non-transitory storage medium storing executable program code which, when executed by a processor, causes the method according to the fourth aspect or the fifth aspect or any of their implementation forms to be performed.

It is noted that all devices, elements, units and means described in the present application could be implemented in the software or hardware elements or any combination thereof. All steps which are performed by the various entities described in the present application, as well as the functionalities described to be performed by the various entities, are intended to disclose that the respective entity is adapted to or configured to perform the respective steps and functionalities. Even if a specific functionality or step to be performed by external entities in the following description of specific embodiments, is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings.

FIG. 1 is a diagram of a transport network slice control device according to an embodiment;

FIG. 2 is a diagram of a TSN control plane entity for a TSN-based TN, according to an embodiment;

FIG. 3 is a diagram of a system comprising a transport network slice control device for a mobile network, and a TSN control plane entity for a TSN-based TN, according to an embodiment;

FIG. 4 is a diagram illustrating network slice management entities comprising the transport slice control device;

FIG. 5 is a diagram illustrating an exemplary transport network for a 5G mobile network for the disaggregated RAN;

FIG. 6 is a diagram illustrating the 5G system as a TSN Bridge;

FIG. 7 is a diagram illustrating an exemplary TSN control for the transport network of the disaggregated RAN;

FIG. 8 is a diagram illustrating a high level representation of the system architecture;

FIG. 9 is a diagram illustrating the transport network slice control device managing NSSI through multilayer TN control;

FIG. 10 is a diagram illustrating different states of the TSN-NSSI;

FIG. 11 is a diagram illustrating an exemplary TSN for 5G mobile network inside a factory-Local scope;

FIG. 12 is a diagram illustrating a procedure for traffic profiling;

FIG. 13 is a diagram illustrating an exemplary procedure for TSN slice instance preparation and installation;

FIG. 14 is a diagram illustrating an exemplarily procedure for TSN Slice instance deletion;

FIG. 15 is a diagram illustrating an exemplarily implementation of the interfaces for a hierarchical CNC, single CUC;

FIG. 16 is a diagram illustrating an exemplarily implementation of the interfaces for a single point of control;

FIG. 17 is a diagram illustrating an exemplarily implementation of the interfaces for a distributed CNC, single CUC;

FIG. 18 is a flowchart of a method for a transport network slice control device for a mobile network, according to an embodiment; and

FIG. 19 is a flowchart of a method for TSN control plane entity for a TSN-based TN, according to an embodiment.

### DETAILED DESCRIPTION OF EMBODIMENTS

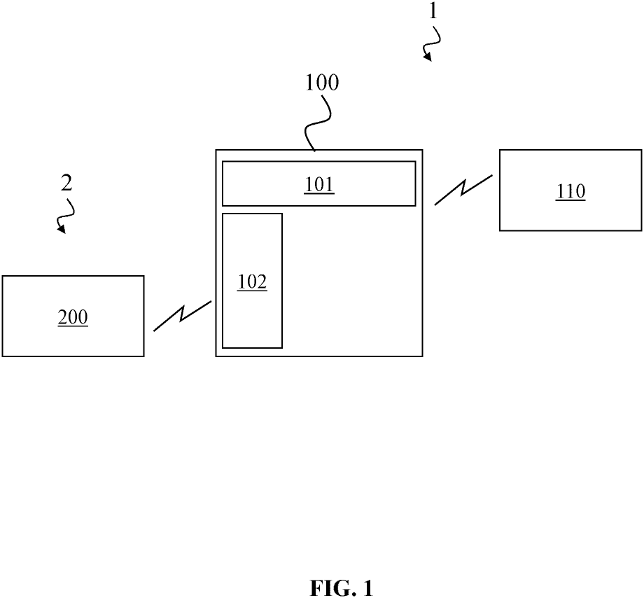

FIG. 1 is a diagram of a transport network slice control device 100 according to an embodiment.

The transport network slice control device 100 comprises a first interface 101 configured to communicate with a transport network slice management entity 110 of a mobile network 1.

The transport network slice control device 100 further comprises a second interface 102 configured to interface with a TSN control plane entity 200 of a TSN-based TN 2.

The transport network slice control device 100 may comprise processing circuitry (not shown in FIG. 1) configured to perform, conduct or initiate the various operations of the transport network slice control device 100 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the transport network slice control device 100 to perform, conduct or initiate the operations or methods described herein.

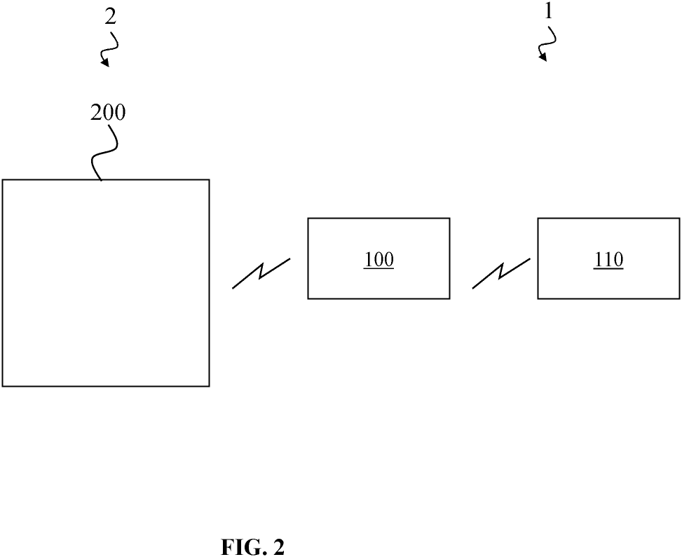

FIG. 2 is a diagram of a TSN control plane entity 200 for a TSN-based TN 2, according to an embodiment.

The TSN control plane entity 200 is configured to receive, through a transport network slice control device 100, network slice management information passed from a transport slice management entity 110 of the mobile network 1.

The TSN control plane entity 200 is further configured to expose capability information of the TSN-based TN 2 to the network slice transport network control device 100.

The TSN control plane entity 200 is further configured to provide the capability information of the TSN-based TN 2 to the network slice transport network control device 100.

The TSN control plane entity 200 may comprise processing circuitry (not shown in FIG. 2) configured to perform, conduct or initiate the various operations of the TSN control plane entity 200 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the TSN control plane entity 200 to perform, conduct or initiate the operations or methods described herein.

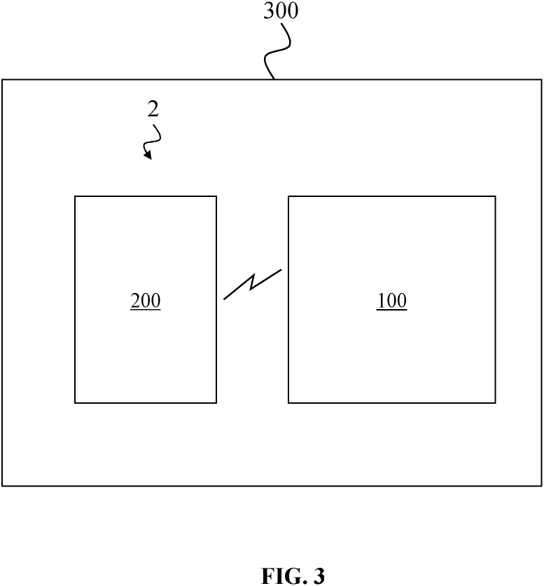

FIG. 3 is a diagram of a system 300 comprising a transport network slice control device 100, and a TSN control plane entity 200 for a TSN-based TN 2, according to an embodiment.

For example, the system 300 may comprise a transport network slice control device such as the transport network slice control device 100 described with respect to FIG. 1, and a TSN control plane entity such as the TSN control plane entity 200 for TSN-based TN 2, described with respect to FIG. 2.

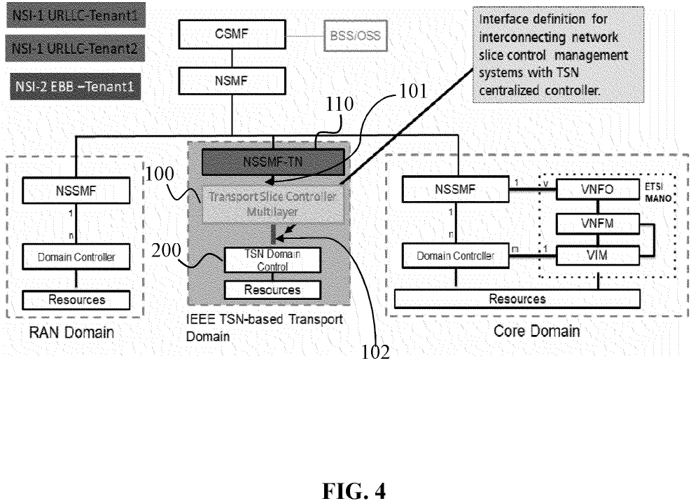

Reference is now made to FIG. 4, which is a diagram illustrating network slice management entities comprising the transport slice control device 100.

The transport network slice control device 100 is exemplarily based on a transport slice multilayer controller comprising the first interface 101 configured to communicate with a transport network slice management entity 110 that is exemplarily based on NSSMF-TN, of a mobile network 1.

The transport slice multilayer controller 100 further comprises the second interface 102 configured to interface with a TSN control plane entity 200 which is exemplarily based on a TSN domain control.

For example, the IEEE TSN may be able to provide Ethernet-based deterministic communications. The transport network slice control device 100 (e.g., the Transport Slice Multilayer Controller as defined by IETF) comprising the first interface 101 and the second interface 102 is configured to communicate with the TSN control plane 200.

In particular, the first interface 101 and the second interface 102 may support network slicing, and may connect the control plane of IEEE TSN-based transport network and Transport Slice Multilayer Controller communicating with the NSSMF entity of the mobile network.

Furthermore, the network slicing requirements may be aligned. Moreover, the network slice instance defined by 3GPP may be mapped to the underlying TSN transport network taking into account the desired transport network performance attributes.

Furthermore, the first interface 101 and the second interface 102 may be used to expose a capability of the TSN transport network, performance attributes and requirements to the 3GPP mobile network NSSMF entity.

Moreover, the signaling part inside the TSN control plane may be augmented to enable per tenant/slice operations. The appropriate data models may be designed and the network slice instance state may be maintained at the transport network level to use it for mapping purposes.

The relevant orchestration and management actions performed by NSMF (and NSSMFs) may be related to, for example, NSIs (and NSSIs) lifecycle management, necessary resource provisioning, and instantiation-configuration actions for the associated resources and NFs, monitoring actions, fault management, and automated healing over the underlying environment (software and hardware).

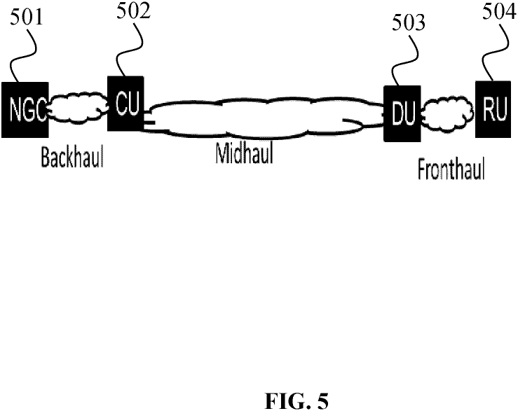

Reference is now made to FIG. 5, which is a diagram illustrating an exemplary transport network for a 5G mobile network.

In the transport network, the fronthaul, midhaul and backhaul communication networks are considered which are used to interconnect NFs (Physical Network Functions (PNFs) and/or Virtualized Network Functions (VNFs)). These terminologies are also used in [3GPP-TR38.803] and [3GPP-TR23.799] by 3GPP, [BBF TR-221], [MEF 22.2] and [ITU IMT2020 O-041] as TN.

Furthermore, in the case where the Disaggregated-RAN paradigm is adopted, these NFs reside in the Centralized Unit (CU) 502, Decentralized Unit (DU) 503, Remote Unit (RU) 504, and the Core Network (CGN) 501.

At next, two examples of integration activities between 3GPP mobile networking and IEEE TSN-based networks including “case 1: TSN for the fronthaul” and “case 2: 5G system as a logical TSN bridge” are discussed as follows.

Case 1: TSN for the fronthaul: 802.1CM Profile for the Fronthaul is based on the area of application, TSN Profiles have been specified to explain which standards, protocols, features and options should be applied for a given use-case. For example, the existing TSN Profiles are 802.1BA for AVB networks, IEC/IEEE 60802 TSN Profile for industrial automation, P802.1DG for automotive in-vehicle Ethernet communications, and IEEE 802.1CM TSN for mobile fronthaul networks. IEEE 802.1CM resulted from a collaborative effort of CPRI and IEEE 802.1. It describes how to meet the stringent fronthaul requirements in an Ethernet-based bridged network which can support not only fronthaul traffic but also other concurrent traffic types. In 802.1CM, both CPRI and eCPRI splits are supported (Class 1 and Class 2 respectively). In both cases the following types of data are considered:
a) User data;
b) Control and Management data; and
c) Synchronization data.

The relevant requirements (for these types of data) may be defined by the CPRI Specification V7.0 and by the eCPRI Transport Network Specification V1.1, respectively. For example, for class 2 (eCPRI), the maximum end-to-end one-way latency is 100 microseconds (us) for high priority user plane data traffic between eREC and eRE. Furthermore, the maximum tolerable Frame Loss probability for control plane data is 10-6, and the internal time error requirements for eRE/RE synchronization varies between 15 to 30 nanoseconds (ns), depending on the case and category. Besides the Fronthaul network, the disclosure considers that TSN bridging can be also used inside the 5G system to support the different components interconnection.

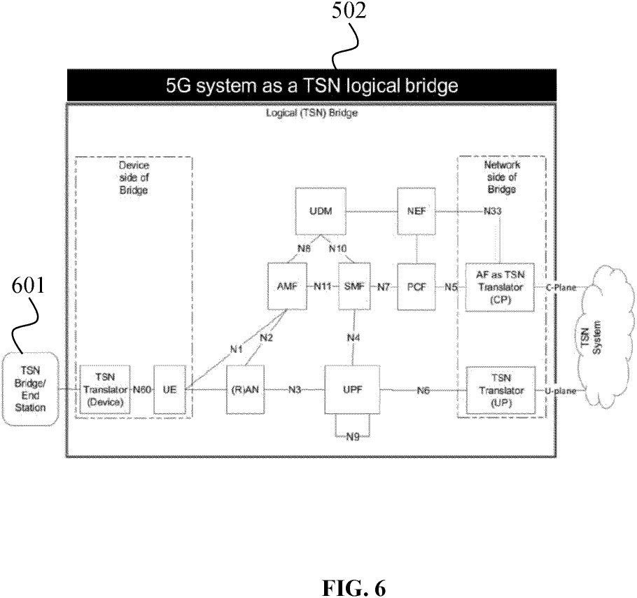

Reference is now made to FIG. 6, which is a diagram illustrating TSN Bridge 601 located outside the 5G box 502.

Case 2: 5G system as a logical TSN bridge: according to liaison activities between 3GPP and IEEE TSN and as described in TS 23.501 clauses 4.4.8, 5.27, 5.28, Annex H, Annex I on support for TSN, and clauses 5.6.10.2, 5.7.6.3, 5.8.2.5.3 on Ethernet forwarding; TS 23.502 Annex F on support TSN; TS 23.503 clause 6.1.3.23 on support for TSN, the 5G system 502 is seen as logical TSN bridge, where translation of requirements and Quality of Service (QoS) parameters are made in UPF (Userplane) and in AF (Control plane). In this case, network slice instance information mapping and resource allocation on the TSN side is also affected by the stream participation on a per slice instance basis inside the mobile network.

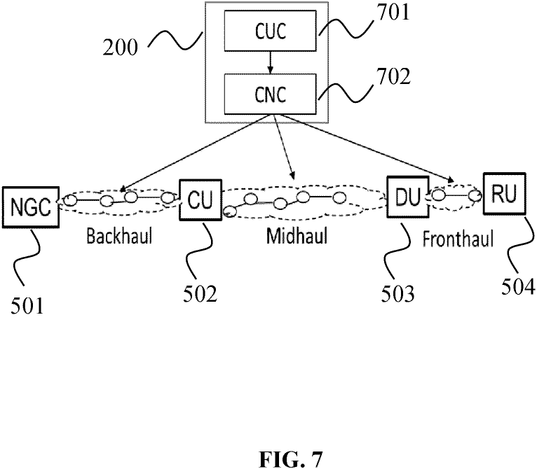

Reference is now made to FIG. 7 which is a diagram illustrating an exemplary TSN-based transport network for the case of disaggregated RAN.

An example of Network Slicing support mechanisms for the integrated TSN-based Ethernet network for 5G is discussed with respect to FIG. 7. The IEEE TSN technologies may be applied not only for the Fronthaul, but also, for the midhaul and backhaul networks, as well. This network integration is called Xhaul.

Moreover, the TSN network slicing mechanism may be applied in a wide range of transport networks (i.e., a backhaul network, a midhaul network, and/or a fronthaul network). Furthermore, one or more interfaces (e.g., the first interface 101 and the second interface 102 of the transport slice control device 100) may be provided. Further, the mechanism are discussed that may be needed toward integration between the network slicing management and orchestration system on the mobile network and the network slice management system in a TSN based transport network.

In more detail, in support of network slicing, one or more interfaces are provided between the slice aware transport network management systems and the TSN control and management planes. In principle through this interface, it may be possible to exploit TSN capabilities in order to realize soft and hard network slices in the transport network.

The present disclosure does not focus on a specific TSN data plane technology like 802.1Qbv or 802.1Qbu, but rather any TSN data plane mechanism may be exploited in order to provide slice isolation and performance guarantees.

For example, one or more of following functionalities may be supported:
The network slicing requirements may be aligned. Moreover, the network slice instance defined by 3GPP may be mapped to the underlying TSN transport network taking into account the desired transport network performance attributes.
Exposing capability of the TSN transport network and performance attributes and requirements to a slice aware Transport Network slice Controller.
Providing the appropriate data models.
Maintaining network slice instance state at the transport network level to use it for mapping purposes.

Moreover, for the control plane of IEEE TSN, currently, there are three models proposed according to 802.1Qcc.

In the following, the control plane of IEEE TSN is considered exemplarily for the fully centralized case, wherein the TSN Centralized Network Configuration (CNC) 702 and TSN Centralized User Configuration (CUC) 701 may be considered as they are defined in IEEE TSN 802.1Qcc. In the following, the first interface 101 and the second interface 102 are provided together with the necessary mechanisms required in order to control the full lifecycle of TSN based Transport Network Slice Instances. The interfaces and the mechanism may also be applied with the case where a distributed protocol like SRP, MSRP is used to advertise stream properties and Talkers/Listeners requirements to CNC through CUC.

The network slicing in 5G may consider two concrete operations. The first operation may be the creation and control of network slice instances. The second operation may be the association of a UE with a specific slice instance. For example, each QoS flow may be identified by a QoS Flow Identifier (QFI), and PDU sessions may be managed by SMF (QFI and QoS profile to the flow based on information provided by the Policy Control Function (PCF) on a per slice basis).

Furthermore, the present disclosure is discussed exemplarily for handling the first operation, i.e., how to create and control Network Slice Instances over a convergent TSN network rather on the process of UE stream association with a NSSI over TSN.

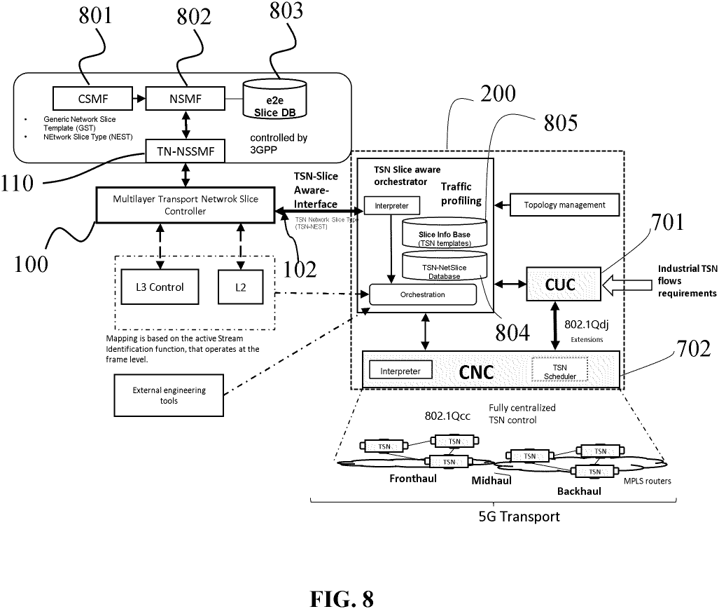

Reference is now made to FIG. 8, which is a diagram illustrating a high level representation of the system architecture.

In the system architecture depicted in FIG. 8, the second interface 102 is exemplarily shown as a “TSN Slice Aware Interface (TSA-I)”, and provided between TSN control plane 200 and Transport Network Slice Controller 100.

Furthermore, new operations inside the CUC TSN management entity and inside the CNC TSN control entity may be supported. In addition, the system architecture depicted in FIG. 8 includes an extensions over 802.1Qdj interface and extensions over “A Yang Data Model for Transport Slice draft-wd-teas-transport-slice-yang-01” interface.

Capability exposure of the TSN-based transport network performance attributes and requirements to the 3GPP mobile network.
Network slicing requirements mapping of the network slice instance defined by 3GPP to the underlying transport topology and to the link interconnections taking into account the desired transport network performance attributes.
Slice request/configure/run/decommissioning actions between the mobile and TSN-based transport networks.
Preserve slice isolation over a TSN-based XHAUL data plane
TSN Coordinated actions through CNC/CUC between engineering tools and Transport Slice Controller.
Backwards compatible with the 5G blackbox approach.

The entities of the system and their functionalities may be as follows:

TN-NSSMF 110: TN-NSSMF is responsible for the orchestration and management of the Transport Network-NSSI counterpart. This entity falls under the control of 3GPP.

E2e Slice-DB 803: this is assumed to be a database infrastructure with all the NSI information. This database infrastructure is controlled by 3GPP and is used to store all the information regarding NSI state, NSI templates, reserved resources, network functions, configurations etc.

Transport Network Slice Controller 100: this entity is defined in IETF in “A Yang Data Model for Transport Slice draft-wd-teas-transport-slice-yang-01”. It is the entity that communicates with TN-NSSMF in order to deliver control and management to configure the different network control elements to deliver the transport slice service. Note that the control plane functionalities for the TN are provided by one or more Domain controllers that are interacting with the TN-NSSFM through the Transport Network Slice Controller. For example a different Domain Controller can be used to control the fronthaul network and a different domain controller for the backhaul network. Different domain controllers can be also assigned to control different administration domains. One control entity for example could be responsible for L2/L3 aspects and another for topology discovery or IP configuration. From an implementation perspective, a single software solution (like an SDN controller) could support all the necessary functionalities. A domain controller can be SDN based. The disclosure herein defines the interface, the Transport Network Slice Controller, and the TSN control/management plane.

TSN-NetSLiceDB 804: a database infrastructure with all the NSSIs′ state information in the TSN TN. This database infrastructure is not controlled by 3GPP and is used to store all the information regarding identification and mappings between NSI and NSSI, store the TSN TN NSSI state, templates, reserved resources, network functions, configurations, etc. It is also the entity where TSN TN NSSI OAM information are stored. For every network element or network service, consider that for each TSN TN NSSI, only specific OAM information is stored at the TN-NSDB that is relevant only with this TSN TN NSSI. This OAM filtering operation could be implemented by a domain controller. However, it is out of scope of the interface specification how this operation is made.

Transport network environment: A TSN based TN is considered. Note, however, that TSN is Layer 2 technology and harmonically operates with other technologies like MPLS, deterministic IP/Detnet, segment routing, etc. in order to deliver the integrated network service.

Slice Aware CUC 701: This is a new design of the CUC entity in order to enable slice awareness. The new interface is used to update stream information with relevant slice identification and essentially enable communication between a Slice aware CUC/CNC with the Transport Network Slice Controller. To enable backwards compatibility with the 5G black-box approach, CUC initially parses slice unaware stream requirements from the different Talkers/Listeners. However in case Network Slicing is enabled prior sending to CNC the relevant stream TSpecs, stream requirements are passed through the new interface to the Transport Network Slice Controller to the management entities (like CSMF) responsible to describe the Slice requirements to NSMF. In case Network Slicing is not enabled, or in case all streams by default belong to a default network Slice, a normal pipeline is followed and stream information is passed through 802.1Qdj to CNC. This is elaborated in the following for the details of the approach.

TSN-NSI Templates: As part of the extended TSN, CUC/CNC TSN-NSI Templates are also considered. A network slice template is used to describe the slice by means of resources, services, configurations, relationships, and service functions chains required by the NSI. The network slice templates actually define all the details required by a network orchestrator to drive all the phases of the NSI lifecycle. For example, a service template is particular for a specific service and needs to define the input parameters, configuration primitives, the relationships/dependencies, resources and constraints, units (number of instances), as well as machines (physical or virtual) and domains of operation. The template also includes the necessary configuration primitives for slice instantiation and operation. For the TSN network the network slice template can be used to define the type of the NSSI like hard or soft slicing, shared or non-shared resources, traffic requirements, and QoS attributes. These templates can augment GNSM Generic Network Slice Template (GST) [gsma] for the TN with TSN attributes. These are used to compile the relevant Network Slice Type (NEST) with TSN information. A Network Slice Type (NEST) is a GST with the values assigned. The invention considers that information passing between CSMF and NSMF should also consider that amendment of slice NEST with the relevant TSN parametrization.

Slice Info Base 805: The definition of such templates can be found in the Slice Info Base.

Slice aware/Tenant aware CNC 702: in principle CNC receives input from CUC 701 regarding configuration requests, from network services like LLDP for topology discovery and from user through given transport protocols. Based on all this input, scheduling decision making is performed for the whole network. However, according to current developments, there is no notion of tenant or slice to group different stream requests in order to optimize the scheduling/forwarding decision. The disclosure considers that for all the stream requests made by the CUC, an additional tenant/slice identifier is also used. After the CNC compiles the forwarding strategy (e.g., scheduling) this is applied to TSN-bridge devices through a management protocol (like NETCONF, Restconf, etc.). One implementation perspective of the invention considers that CNC has direct access to the Slice Info Base and the TSN aware TN-NEST. All the interfacing between the TSN control plane 200 and the Transport Network Slice Controller 100 can be handled by a TSN orchestrator used for message interpretation, while also for interfacing with other TN control systems to cope with complexity minimization and relevant optimization decision making. By means of implementation TSN orchestration can be implemented either as a standalone entity or as part of the CNC.

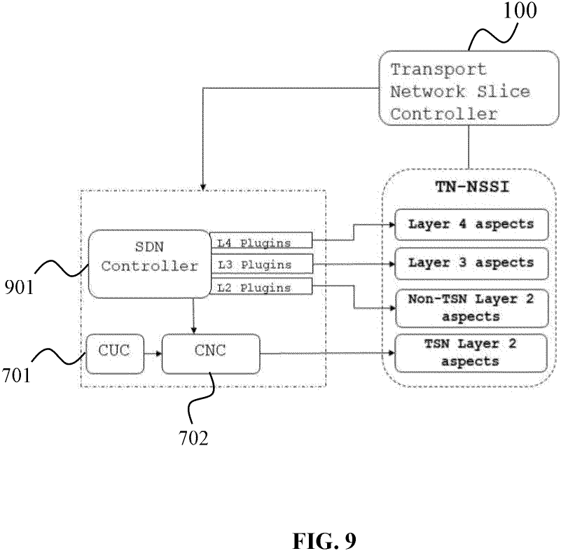

Reference is now made to FIG. 9 is a diagram illustrating the transport network slice control device 100 managing TN-NSSI through multilayer control.

The control actions supporting the TN slice instance (i.e., TN-NSSI) lifecycle may be triggered by the Transport Network Slice Controller 100.

For example, for any TSN related aspects as part of the TN-NSSI instance, the TSN control plane entity 200 is responsible to preserve the proper TSN functionality. Note that for the overall TN, the network functionality may be supported by an orchestrated control mechanism, where CNC 702 together with L2/L3/L4 control may tune the TSN aspects and the L2/L3/L4 aspects, respectively.

Further, there may also be an interface between SDN controller 901 and the CNC 702.

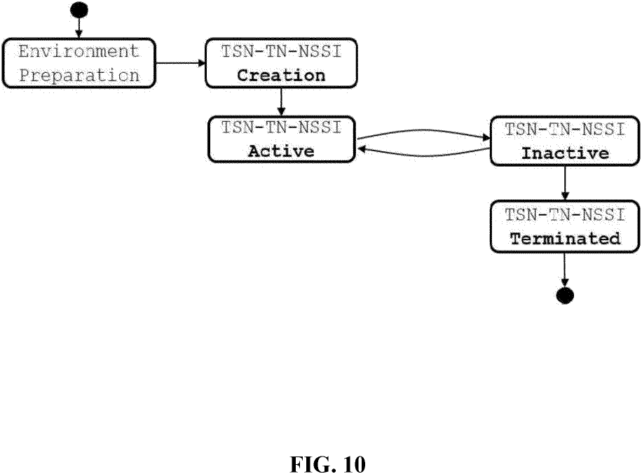

Reference is now made to FIG. 10 which is a diagram illustrating different states of the TSN-NSSI.

The relevant state transitions are depicted for the TSN-TN instance lifecycle. Further, it may be considered the following roles, “have” relationships and procedures:
Each tenant owns a set of NSIs.
Each mobile network user may be associated to a set of NSIs belonging to multiple tenants.
The PDU session establishment has the responsibility of the 3GPP control plane functionalities. For instance, according to 3GPP [TS 23.501], a specific PDU session makes use of a single network slice, and different PDU sessions may belong to different network slices.
A TSN TN slice aware identification mechanism, management aspects, and procedures are handled by the TSN control plane.
The TSN-TN only provides the necessary TSN dataplane to carry traffic on a per tenant/NSSI basis.
The procedure to map NSI to TN-NSSI(s) is made by the TN-NSSMF.
The procedure to orchestrate TSN TN-NSSI(s) is made by CUC-CNC. Additional interaction between CNC and Software Defined Network controllers (SDN) enables other L2,L3/L4 control aspects, like topology management and clock configuration.
The procedure to control the operation of the TSN TN-NSSI(s) is made by the CNC.
It may be assumed that one single converged TSN network is used for 5G user plane and control plane traffic, but also for non 5G related flows (for example, in industrial environments PROFINET over TSN traffic).
CNC is responsible to control TSN and non-TSN aware streams (like PROFINET).
Both CUC and CNC become/tenant slice aware.
The CNCs southbound is slice unaware (following 802.1Qcw amendment).
The CNC northbound is slice aware. This may be achieved through extensions over 802.1Qdj, and also with direct exposure of the Slice aware NSSI databases to the CNC.
The interface between NSSMF (3GPP) and Transport Slice Controller specified by IETF is also extended to cover TSN requirements and configuration information.
Extensions are covering the capabilities exposure of the TSN transport network performance attributes and requirements to the 3GPP mobile network.
For both the 3GPP Network Slicing Architecture and the Network Slice Instance Selection and Association procedures, the disclosure is aligned with the work delivered in [TR23.799],[TS23.501] and [TS23.502] for the specification of the NextGen RAN and Core, without limiting the present disclosure. Note that the control plane for the TN is not part of the NextGen Core and the NextGen RAN control plane. Rather, it operates independently.
In the process of creating an NSI, NSMF may need to ensure that the usage of the TSN TN parts for the network meets the network slice requirements. In order to achieve isolation between NSIs when using the TSN-TN links, traffic corresponding to different NSIs may also be differentiated at the TSN-TN level. This may be achieved by providing NSI specific TN parameters to each node. These TN parameters may correspond to NSI specific IP address allocation, or L2 parameters such as VLAN tags [TR28.801-7.11], however, the disclosure considers that this needs to be also extended to cover the case of TSN. This information includes the corresponding TSN TN parameters to be used for associated transport links.

At next, slice specific operations from the augmented TSN control and management planes will be discussed.

Slice, Resource and Service Identification: the identification of NSIs, TN-NSSIs, TN-resources, TN-NFs, TN-interfaces, etc., is an important topic towards NSMF and TN-NSSMF integration, in order to provide end-to-end NSIs.

Network Slicing Identification in 3GPP: the system architecture for the Next Generation 5G RAN and Core, and the interfaces are defined in, for example, “TS 23.501”. Moreover, the procedures in the control plane are discussed in, for example, “TS 23.502.” Some of the identification primitives are discussed in, for example, “TS 23.501-section 5.15.2”, “TS38.300”, and some are also used in “TR23.799” such as the NeS_ID, S-NSSAI, Tenant_ID, Temporary_ID, Token, Tracking Area identity (TAI) etc.

Furthermore, the 3GPP already defined some of the identifiers necessary for network slicing, without providing the data types, however (such an approach is used in the specifications). The list is not exhaustive, and it may intuitively be considered that every component or element can have a corresponding identifier. For example, a NSI has a NSI_ID, a NSSI has a NSSI_ID, a NF has also a NF_ID and so on, which can be used by the NSMF.

Existing identifiers like PLMN_IDs, logical channel identifiers, session identifiers and so on, can all be exploited by the slice aware orchestration and management system.

Identification mechanisms for the TN: for the TSN network part regarding the TN-NSSIs that are related to the assembly of one or multiple NSIs, it may be assumed that a similar identification mechanism exists that may assign, for example, a (TN)NSSI_ID and may further map it to the NSI_ID (provided by the NSMF). This information may be stored in the TSN-NetSLiceDB.

Note that, in the Transport Network Slice controller technology, agnostic and technology specific parts may exist, for example, each one may have an identification mechanism. In the present disclosure, two categories of (category A and category B) of IDs are considered that are used by a TSN CUC/CNC in order to become Slice Aware:
Category A: identifiers related to the NSSI lifecycle.
Category B: identifiers for TSN network exposure (e.g. node_1, link_5, pre-emption_supported etc.).

Furthermore, it may be considered that the way identification information is made is local to the TSN TN environment, and is only exposed by Transport Network Slice controller to the CUC/CNC. Moreover, it may also be assumed that for the TN-NSSI all the relevant information is stored in the TSN-NetSLiceDB, where depending on the data types for each element, the appropriate database table structures are used.

Note that the definition of all the messages that are passed require a specific schema structure of elements and sub-elements, together with their data types. For example, a TSN_NSSI_ID may be represented by an integer or a uuid value. For example, the message schema definition (assuming XML format) may be as follows:

### Case 1 (Using Integer ID):

<xsd:element name=“TSN_NSSI_ID” type=“xsd:integer″/>

### Case 2 (Using Uuid Id): If It Is Uuid, First A New Data Type Needs to Be Defined (Named Guid in The Example):

<xsd:simpleType name=“guid″>
<xsd:restriction base=“xs:string″>
<xsd:pattern value=” [0-9a-fA-F]{8}-[0-9a-fA-F]{4}-[0-9a-fA-F]{4}-
[0-9a-fA-F]{4}-[0-9a-fA-F]{12}“/>
</xsd:restriction>
</xsd:simpleType>
Then <xsd:element name=“TSN_NSSI_ID” type=“xsd:guid “/>

Examples with the status of the NSSI or the NSSI start time could be the following:
<xsd:element nssi_status=“active” type=“xsd:boolean”/> and
<xsd:element nssi_start_time=“StartTime” type=“xsd:dateTime”/>

NSI Isolation: the functionalities needed to satisfy the TN-NSSI isolation requirements are provided by the corresponding TSN data plane mechanisms (such as 802.1Qbv, 802.1Qbu, 802.1Qcr, etc.). Note that, a TN-NNSI may be fully or partly, logically and/or physically isolated from other TN-NSSIs. Furthermore, different levels and types of isolation/separation may be required, such as Slice Security isolation, Resource isolation, and OAM support isolation (e.g., Usage and Fault isolation, etc.). However, in the case when multiple customers share the same TSN-NSSI functionality, or different NSI share the same NSSIs, management data isolation is difficult to achieve. However, it may be assumed that the necessary mechanisms are provided and enabled by the CNC domain control for the technology specific TSN-based TN environment, in such a way that the slice isolation is preserved.

For example, for the TSN-based data plane isolation between different NSSIs, traditional techniques like VLAN can be used to isolate the traffic through physical or logical channels that support the TN-NSSI. As Slice specific information is passed to the CNC entity, optimized scheduling decisions can also be used to support QoS/performance guarantees on a per slice basis.

Slice-aware TSN network Orchestration: through the interfaces (e.g., the first interface 101 and/or the second interface 102) alignment of network slicing requirements and mapping of network slice instance defined to the underlying TSN transport topology and to the link interconnections is made, taking into account the desired transport network performance attributes.

The present disclosure also considers augmentation of the CUC/CNC with orchestration mechanism that takes the following information as input:
TSN slice —aware information/requirements/policies for network slices through the interfaces defined in the invention.
Decision making based on stream specification and TSN Stream mapping based on the active Stream Identification function that operates at the frame level.
Per slice stream profiling - session dynamicity handling/filtering/aggregation.
As TSN can be used as a converged network over which other traffic can pass concurrently with 5G flows input from other network controllers or engineering tools. For example, in industrial networks engineering tools can describe the requirements of Profinet or Modbus traffic over TSN.
Traffic prediction module: as in the case of applying TSN over 5G-XHAUL flow dynamicity complicates the decision making inside CNC, we consider a traffic profiling module can operate (instead of statically defining the traffic requirements) in order to facilitate optimal decision making. From one implementation perspective, this module can operate inside CNC. From another perspective, it could be implemented as part of the TSN orchestrator (or even inside CUC). However, it could also be independent and expose service in both CUC/CNC.

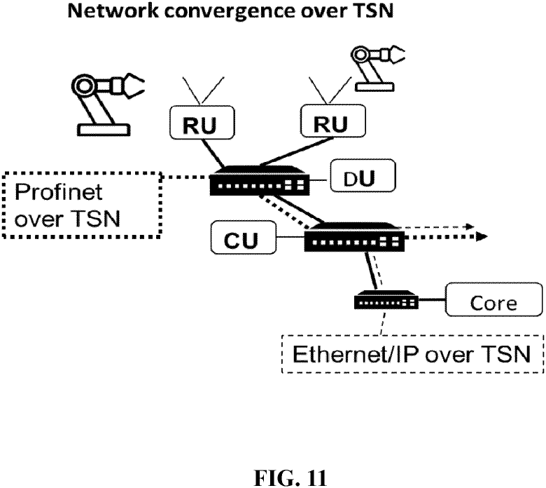

Reference is now made to FIG. 11, which is a diagram illustrating an exemplary TSN for 5G mobile network inside a factory-Local scope.

Tspec passing and CUC/CNC role on the process: according to TS23.501 the black-box approach is described for TSN integration with the 5G system, wherein the operations inside the 5G system are agnostic to the relevant operations inside the TSN control plane. For example, the communication between the two systems may be performed through interaction of the TSN CNC with AF-TT, where a translation service may pass the requirements of the TSN streams to the 5G system. The stream requirements are passed from CNC the 5G system that is acting as a transparent TSN bridge. Then, inside the 5G, the relevant resource allocation is made in order to support the QoS required for these TSN streams.

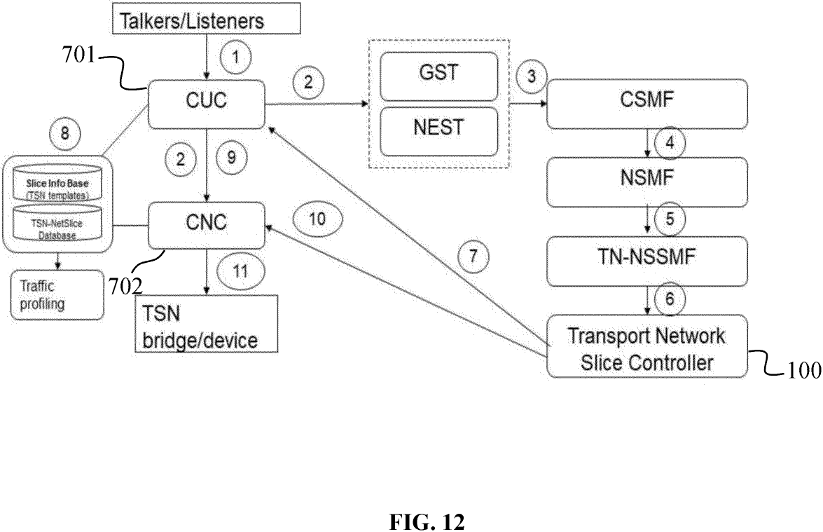

However, in the present disclosure, a traffic profiling mechanism is introduced, since in the case of network slicing, resource allocation is made proactively and not necessary on per stream basis. This means that the provision of the network slice is made a priori with full or partial knowledge of the exact streams that may traverse through the TSN network. The process is described in FIG. 12 discussing an example of traffic profiling.

Reference is now made to FIG. 12 which is a diagram illustrating a procedure for traffic profiling.
Step 1: Following the black-box approach, CUC 701 is gathering stream requirements from TSN Talkers and Listeners.
Step 2: Information is passed from CUC 701, not only to CNC 702 (normal process), but is also used to contract TSN aware GST/NEST.
Step 3: After TSN-aware NEST is prepared, CSMF is contracting the overall network slice request. Note that it is considered that over the TSN network, not only time critical flows will pass over the TSN network (and not only the ones advertised initially by CUC 701). Rather, TSN can be used to support any type of L2 TSN connectivity.
Step 4: After the e2e Slice definition is prepared, CSMF is triggering the request for an e2e slice to NSMF.
Step 5: NSMF calls the necessary counterparts (RAN NSSMF, Core NSSMF, TN NSSMF) to request resources that will satisfy the QoS and requirements for the flows described in NEST.
Step 6: For the TN part, TN-NSSMF calls Transport Network Slice Controller 100 that is responsible for all the control aspects on per slice basis.
Step 7: Transport Network Slice Controller 100 communicates back to CUC 701 the now slice aware stream definitions, together with additional flows specified in NEST, and will traverse the TSN network.
Step 8: The relevant databases are updated with the new slice aware identification. At this point also, traffic profiling takes place, where traffic modelling and regression analysis can be used in order to provision a future traffic load prior to scheduling decision making.
Step 9: The new slice aware requirements are passed to CNC 702.
Step 10: Transport Network Slice Controller 100 also interacts with CNC for other parameterization necessary for TSN network tuning.
Step 11: CNC 702 performs optimal decision making and configures the TSN bridges accordingly.

Regarding runtime operations, the control loop may be the same, but without steps 1 to 3. According to runtime operations (new nodes, flows entering, leaving the network, etc.) the definition of NEST is adjusted accordingly, and resource relocation may also takes place. Note that this design preserves backwards compatibility with the network slice unaware case, since, for example, the CNC 702 still interacts with AF, e.g., when attachment of the flows is made for QoS provisioning and for the mapping procedures. In order to trigger the network slice awareness, a simple ON/OFF module can operate inside TSN control plane.

At next, the interface (first interface 101 and the second interface 102) description and specification are presented.

A TSN slice aware interface: it may be assumed that a vendor-independent representation is used for the configuration and interaction with the TSN TN network elements (i.e., routers and switches). For example, OpenConfig is providing vendor-neutral models for network element configuration and operational state using the YANG language [RFC 6020], while for the transport protocol or serialization three potential candidates are: a) NETCONF with XML encoding over SSH, b) RESTCONF over https using for example JSON representation, and c) gRPC: Google’s open-source protobuf with RPC on top of HTTP. A SDN control plane can be used for the realization of the TN Domain controller(s) in multiple implementation scenarios.

Description: for example, the description may be if the interface is used for all the communication between TSN CUC/CNC control and orchestration system and the Transport Network Slice Controller 100 of slice aware transport networks?

For example, the interfaces may be used for all the message transfer to support TSN functionality for the entire lifecycle of TN-NSSIs, and are also used for the capabilities exposure of the TSN TN.

Stakeholders: the interfaces may be exploited by the transport network builders and 3GPP system integrators. This may enable third parties like enterprises, service providers, or content providers to efficiently operate network slices over a converged TSN network.

Requires: TN-NSSMF entity and the Transport Network Slice Controller is operational and a communication channel is established between the Controller and the TSN-CUC/CNC.

Communication protocol, connection establishment, maintenance, termination: the Transport Network Slice Controller 100 initiates the connection with CUC/CNC, applying a number of parameters that need to be configured in advance, like the IP address and port, and the transport protocol to use (like TLS or TCP). In case a REST interface is exposed by the CUC 701, then the communication can be over https.

For the initial connection establishment, the maintenance and the termination of the connection specific messages need to be exchanged. For the initial version of the interface, it may be considered that the relevant protocol may operate over a synchronous point to point communication. However, all possible modes of communication may be considered, such as publish/subscribe, multipoint-to-multipoint communication, synchronous, asynchronous and so on. Furthermore, regarding authentication and encryption, TLS/SSL cryptography may be used to protect the data integrity on the transport channel. Regarding authorization, it may be assumed that this is handled by the Transport Network Slice Controller function.

For all the communication patterns necessary, it may be assumed that an event-driven mechanism exists where events are generated in two ways, including: a) automatic generation of events (periodic or aperiodic), and b) on-demand generation of events. Each event may generate a message that is sent through the Slice Aware TSN Interface.

Issues like fragmentation and re-assembly of messages, acknowledgements, packet errors, flow control, and routing are handled by lower layers of the protocol stack. There is no specific tunneling requirements and the initial interface protocol stack just exploits TCP/IP.

For the first version of the interface, it may be that there are no priorities defined for specific NSSIs and all the requests are handled by the CNC in a First-Come-First Served fashion.

Messages Specification: the disclosure identifies the following messaging categories for the exchange of information between the Transport Network Slice Controller and the TSN control plane:

| | |
|---|---|
| Message Category | Description |
| Category A | TSN TN-NSSI lifecycle management and TSN TN-NSSI state transitions: e.g., TSN NSSI Creation, Activation, De-activation, Termination, and Modification. |
| Category B | TSN NSSI Monitoring-Supervising |
| Category C | TSN TN Capabilities exposure and TSN TN-subnetwork status |
| Category D | Error handling and fault management |
| Category E | Connection management |

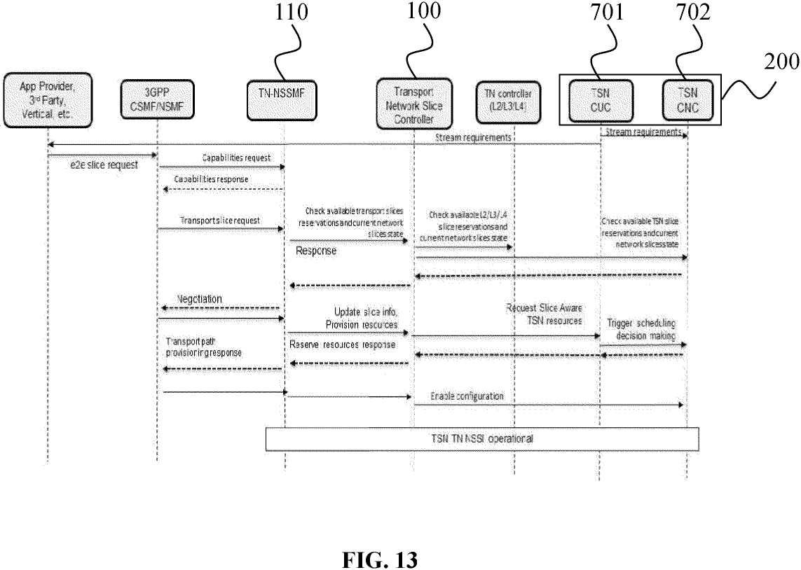

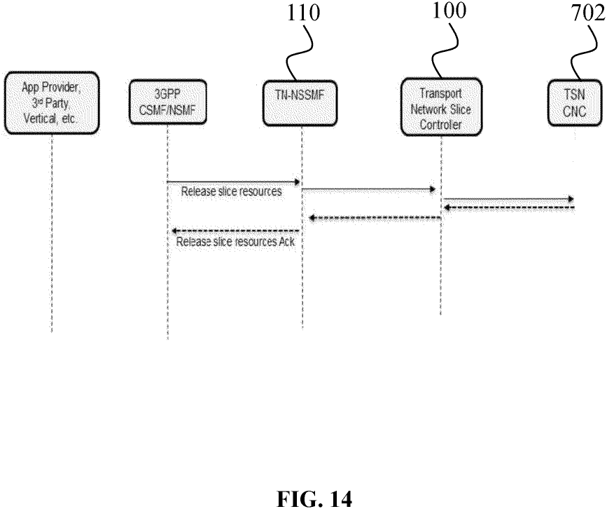

Exemplarily procedures for TSN slice preparation and installation, and TSN Slice deletion, are shown in FIG. 13 and FIG. 14, respectively.

Exemplarily design options are discussed for the implementation of the interfaces.

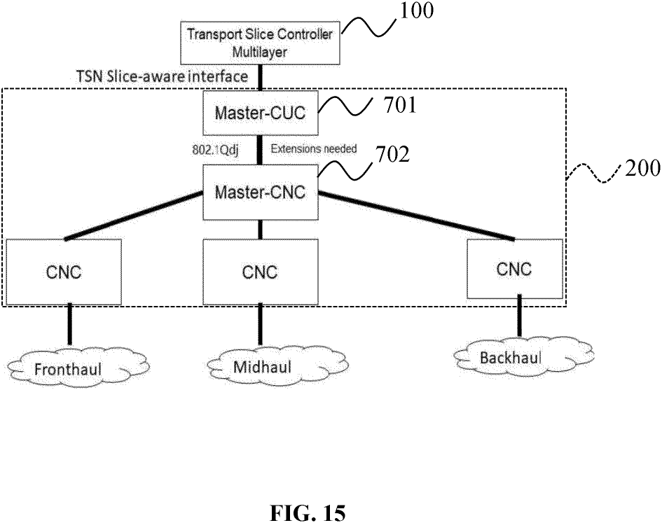

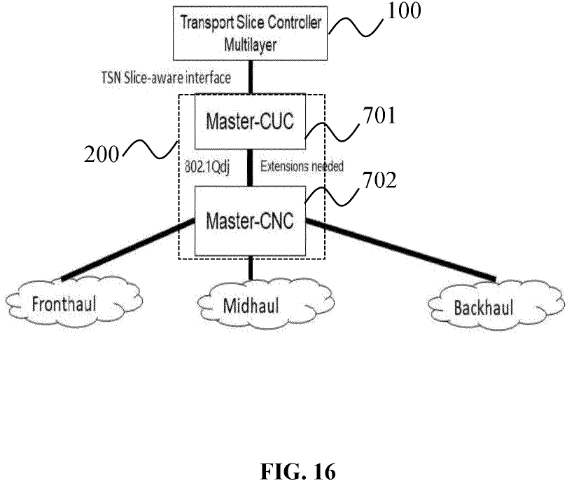

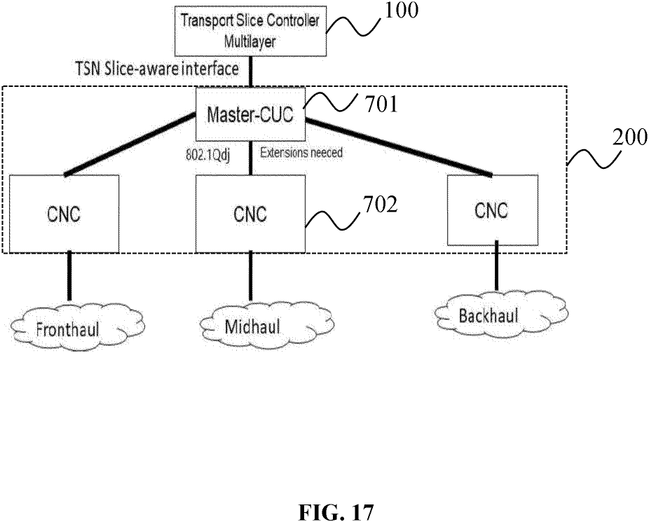

An example of a design options for the implementation of the interfaces for a hierarchical CNC is shown in FIG. 15. Another example of a design options for the implementation of the interfaces for a single CUC/CNC control is shown in FIG. 16, yet another design options for the implementation of the interfaces for a distributed CNC is shown in FIG. 17.

An embodiment may be based on a TSN network convergence in factory floor, including 5G-Slicing, Profinet, and others.

Moreover, end-to-end performance may be affected by in-class interference. Further, according to the disclosure, the TSN updates on a per TN slice update and other industrial networks requirements. Also, the new interface processes may also be designed as described above.

An embodiment may be based on an inter-slice mobility.

For example, the existing 3GPP standard procedures only enable users to change (or switch) slices. They lack formal mechanisms for session continuation among slices, and thus need to be enhanced to achieve seamless inter-slice mobility or handovers. End-to-end performance is affected by Inter-slice mobility, since TSN QoS/ scheduling can be oriented to a specific slice -Talkers/Listeners pairs.

According to the present disclosure, the TSN updates on a per TSN slice update, and on a per user slice participation update. Also, the new interface processes may also be designed as described above.

In an embodiment, message specification for Transport Network Slice request may be provided.

For example, the following message specification is a statement of how a network slice request is defined.

Service provided: Network slice request for TSN TN resources.

Preconditions: conditions that must prevail before the service is invoked.
CUC/CNC are operational to support TSN domain control mechanisms.
The communication channel between CNC and Transport Network Slice controller is operational.
TSN-NSDB holds all the state information for all the TSN-TN-NSSIs.
TSN-NSDB holds all the resource reservations for all the TSN-TN-NSSIs.
A TN-NSSI create/activate/de-activate/terminate operation is not in progress.

Post-conditions
A new TN-NSSIs is created.
The NSMF has been notified.
TSN Dataplane supports NSSI connectivity.

A message schema in xsd format may be as follows:

<?xml version=“1.0”?>
<xs:schema xmlns:xs=“http://www.huawei.com/temp”
targetNamespace=“http://www.huawei.com/temp_namespace”
xmlns=“http://www.huawei.com/temp_namespace”>
<xs:element name=“nssi_request”/>
<xs:complexType>
<xs:sequence>
1.1 <xsd:element slice_id: int type=“xsd:integer”/>
1.2 <xsd:element slice _duration=“duration” type=“xsd:double”/>
<xsd:element slice_init_time=“StartTime” type=“xsd:dateTime”/>
<xsd:element slice_police=“slice_policy” type=“xsd:slice_policy”/>
<xsd:element nssi_start_time=“StartTime” type=“xsd:dateTime”/>
<xs:element name=“hard_slice_support”/>
</xs:complexType>
<xs:attribute name=“support” type=“xs:boolean” />
<xs:attribute name=“type” type=“xs:enumeration” />
</xs:complexType>
<xs:element name=“soft_slice_support”/>
</xs:complexType>
<xs:attribute name=“support” type=“xs:boolean” />
<xs:attribute name=“type” type=“xs:enumeration” />
</xs:complexType>
<xs:element name=“performance” >
<xs:complexType>
<xs:sequence>
<xs:element name=“number_of_streams” type=“xs:decimal”/>
<xs:element name=“max_latency” type=“xs:decimal”/>
<xs:element name=“min_bandwidth” type=“xs:decimal”/>
<xs:element name=“max_bandwidth” type=“xs:decimal”/>
<xs:element name=“max_jitter” type=“xs:decimal”/>
<xs:element name=“packet_loss_probability” type=“xs:decimal”/>
</xs:sequence>
</xs:complexType>
</xs:element>
<xs:sequence>
<xs:complexType>
</xs:schema>

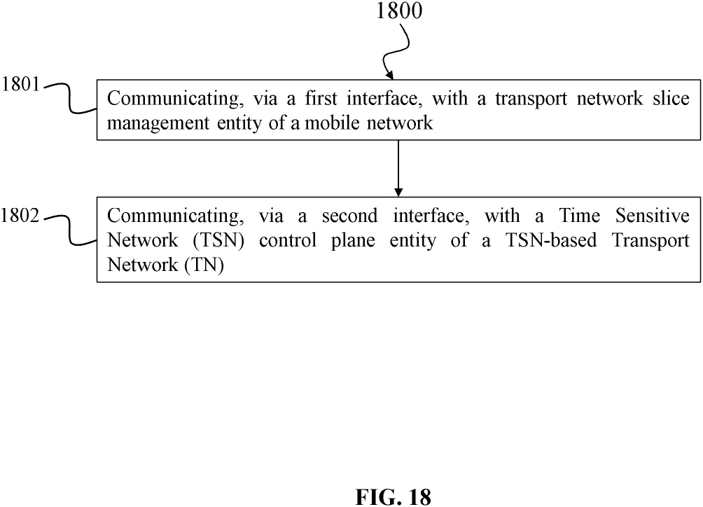

FIG. 18 is a flowchart of a method 1800 for a transport network slice control device for a mobile network. The method 1800 may be carried out by the transport network slice control device 100, as described above.

The method 1800 comprises a step 1801 of communicating, via a first interface 101, with a transport network slice management entity 110 of a mobile network 1.

The method 1800 further comprises a step 1802 of communicating, via a second interface 102, with a TSN control plane entity 200 of a TSN-based TN 2.

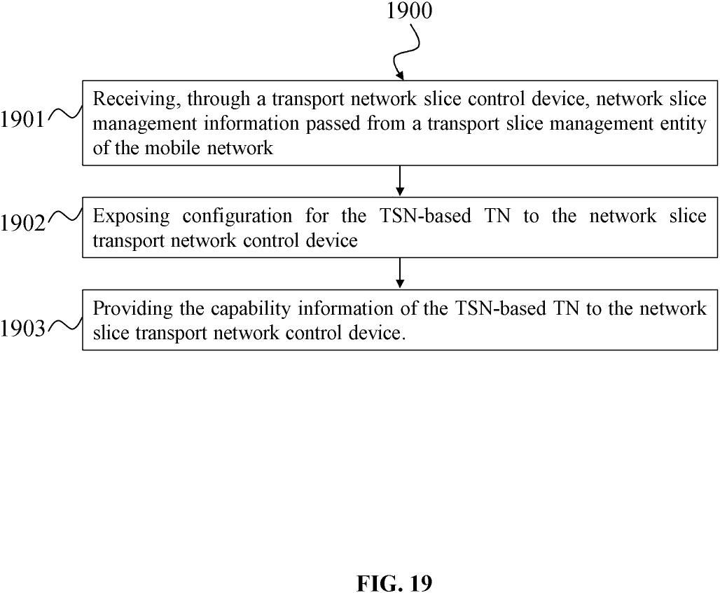

FIG. 19 is a flowchart of a method 1900 for a TSN control plane entity for a TSN-based TN according to an embodiment .

The method 1900 further comprises a step 1901 of receiving, through a transport network slice control device 100, network slice management information passed from a transport slice management entity 110 of the mobile network 1.

The method 1900 further comprises a step 1902 of exposing configuration information for the TSN-based TN 2 to the network slice transport network control device 100.

The method 1900 further comprises a step 1903 of providing the capability information of the TSN-based TN 2 to the network slice transport network control device 100.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A transport network slice control device, the transport network slice control device comprising:
a first interface configured to communicate with a transport network slice management entity of a mobile network; and
a second interface configured to communicate with a Time Sensitive Network (TSN) control plane entity of a TSN-based Transport Network (TN).

2. The transport network slice control device according to claim 1, further configured to perform one or both of:
communicate, via the first interface, network slice control and management information with the transport network slice management entity of the mobile network; or “”
communicate, via the second interface, network slice control and management information required by the TSN network, with the TSN control plane entity.

3. The transport network slice control device according to claim 1, the network slice management information comprising one or more of:
a TSN-TN network slice requirement information;
a TSN-TN slice instance creation request;
a TSN-TN slice instance creation response;
a TSN-TN slice instance state information;
a TSN-TN slice instance policy information;
a TSN-TN slice instance configuration information;
a TSN-TN slice instance run action;
a TSN-TN slice instance decommissioning action;
a soft TSN slice instance capability; or
a hard TSN slice instance capability.

4. The transport network slice control device according to claim 1, further configured to perform one or both of:
receive, via the first interface, updated TN slice information or updated TN slice resource provision from the transport slice management entity of the mobile network; or
send, via the second interface to the TSN control plane entity, the updated TN slice information or the updated TN slice resource provision.

5. The transport network slice control device according to claim 1, further configured to:
receive, a TN slice isolation requirement from the transport network slice management entity; and
maintain a TN slice isolation over a TSN-based data plane, based on the received TN slice isolation requirement.

6. A Time Sensitive Network (TSN) control plane entity for a TSN-based Transport Network, (TN), the TSN control plane entity being configured to:
receive, through a transport network slice control device, network slice management information passed from a transport slice management entity of the mobile network;
expose capability information of the TSN-based TN to the network slice transport network control device; and
provide the capability information of the TSN-based TN to the network slice transport network control device.

7. The TSN control plane entity according to claim 6, further configured to:
store information in a network slice database; and
provide information related to a lifecycle of one or more transport network slice instances to a control plane entity of the TSN-based TN.

8. The TSN control plane entity according to claim 6, the network slice management information comprising one or more of:
a TSN-TN network slice requirement information;
a TSN-TN slice instance creation request;
a TSN-TN slice instance creation response;
a TSN-TN slice instance state information;
a TSN-TN slice instance policy information;
a TSN-TN slice instance configuration information;
a TSN-TN slice instance run action;
a TSN-TN slice instance decommissioning action;
a soft TSN slice instance capability; or
a hard TSN slice instance capability.

9. The TSN control plane entity according to claim 6, further configured to:
obtain, from the transport network slice control device, a determined TN performance attribute; and
map, based on the determined TN performance attribute, the received network slice management information from the transport slice management entity to TSN specific performance attributes of the TSN-based TN on a per slice basis.

10. The TSN control plane entity according to claim 6, further configured to:
receive, from the transport network slice control device, a TN slice isolation requirement received from the network slice transport network management entity of the mobile network; and
maintain a TN slice isolation over a TSN-based data plane, based on the received TN slice isolation requirement.

11. The TSN control plane entity according to claim 6, is based on a network slice aware TSN control plane entity comprising:
a Centralized Network Configuration (CNC) TSN control entity configured to control a TSN TN-Network Slice Sub network Instance (NSSI); or
a Centralized User Configuration (CUC) TSN control configured to pass requirements of a TSN TN-NSSI stream specification to CNC.

12. The TSN control plane entity according to claim 11, wherein the CNC is further configured to control one or more of a TSN slice aware operation or a TSN non-TSN slice aware operation.

13. The TSN control plane entity according to claim 6, comprising a database configured to store, for each TN NSSI resource, one or more of allocation information, resource identification, or mapping information regarding stream performance attributes.

14. A method for a transport network slice control device for a mobile network, the method comprising:
communicating, via a first interface, with a transport network slice management entity of the mobile network; and
communicating, via a second interface, with a Time Sensitive Network (TSN) control plane entity of a TSN-based Transport Network (TN).

15. A method for a Time Sensitive Network (TSN) control plane entity for a TSN-based Transport Network (TN), the method comprising:
receiving, through a transport network slice control device, network slice management information passed from a transport slice management entity of the mobile network;
exposing capability information of the TSN-based TN to the network slice transport network control device; and
providing the capability information of the TSN-based TN to the network slice transport network control device.
